(19) United States
(12) Patent Application Publication
(10) Pub. No.: US 2009/0052106 A1
(43) Pub. Date: Feb. 26, 2009

(54) CONTROLLABLE DRIVE APPARATUS

(75) Inventor: Michael FUCHS, Vlotho (DE)

Correspondence Address: BARNES & THORNBURG LLP, 750-17TH STREET NW, SUITE 900, WASHINGTON, DC, 20006-4675, US

(73) Assignee: ARI-Armaturen Albert Richter GmbH & Co. KG, Schloss Holte-Stukenbrock (DE)

(21) Appl. No.: 12/189,899

(22) Filed: Aug. 12, 2008

(30) Foreign Application Priority Data
Aug. 21, 2007 (DE) DE 202007011641.1

(51) Int. Cl. H01F 7/18

(52) U.S. Cl. 361/139

(57) ABSTRACT

A drive apparatus is controllable by a three-point actuating signal, with a drive for driving an actuator, the drive apparatus having a matching circuit for matching the three-point actuating signal to predeterminable parameters.

### CROSS-REFERENCE TO RELATED APPLICATIONS

This application is a U.S. patent application that relies for priority under 35U.S.C.119, on German Patent Application No. 20 2007 011 641.1, filed on Aug. 21, 2007, which is incorporated herein by reference.

The invention relates to a drive apparatus which can be controlled by a three-point actuating signal for driving actuators.

The actuators to be driven are, for example, so-called three-way valves, as can be used in domestic and process technology installations for controlling flows of fluid. Such actuators and their use are known to a person skilled in the art and will therefore not be explained in any more detail at this juncture.

Known drive apparatuses which can be controlled by a three-point actuating signal for driving actuators can only be controlled by a three-point actuating signal which is configured specifically for them, since the known drive apparatuses are only designed for a specific three-point actuating signal of a certain type of voltage, a certain level of voltage (and/or current level) and a certain frequency of the signal.

Since different voltage systems exist, for example in other countries (for example, Germany/Europe AC, 230V, 50 Hz or USA AC, 120V, 60 Hz), under certain circumstances different three-point actuating signals result at different use locations. If there is therefore the need to control the known drive apparatuses by means of different three-point actuating signals, different drive apparatuses which are matched to the respective three-point actuating signal need to be used.

The known drive apparatuses are therefore affected by the disadvantage that they are only designed for a specific three-point actuating signal. Consequently, different drive apparatuses need to be used for different three-point signals. This is associated with a high degree of financial expenditure.

Accordingly, illustrated embodiments provide a drive apparatus which eliminates the problems described using a drive apparatus having features recited in the claims.

According to the illustrated embodiments, the drive apparatus has a matching circuit for matching the drive apparatus to different three-point actuating signals corresponding to predeterminable parameters. As a result, a drive apparatus is provided which can be controlled by three-point signals which differ from one another in terms of their type of voltage, voltage and/or current level and frequency, with the result that it is no longer necessary to provide different drive apparatuses.

The illustrated embodiments will be explained in more detail below with reference to an exemplary embodiment in connection with the attached drawing, in which:

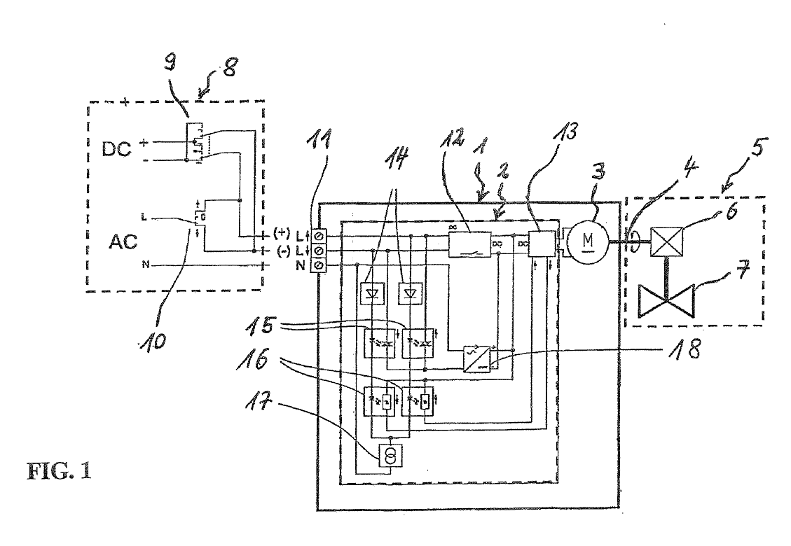

FIG. 1 shows a drive apparatus according to the illustrated embodiments, a schematically illustrated actuator and a schematically illustrated circuit arrangement for the exemplary generation of three-point actuating signals.

FIG. 1 shows a drive apparatus 1 according to the illustrated embodiments, which can be controlled by a three-point actuating signal and has a matching circuit 2 according to the invention and a drive 3. Furthermore, an actuator 5, which is connected to the drive 3 via a rotary spindle 4 and can be driven thereby, with a transmission 6 and a valve 7 is also illustrated.

Limit switches or similar devices which may be required for the operation of actuators are not illustrated for reasons of clarity. Such devices and the way in which these devices function are known to a person skilled in the art and are, therefore, not described in any more detail in the present disclosure.

The drive apparatus 1 is connected to a circuit arrangement 8 for generating Direct Current voltage (DC voltage) three-point actuating signals or Aleternating Current (AC voltage) three-point actuating signals via terminals, in this case an input terminal block 11, by means of electrical connections (not illustrated). The circuit arrangement 8 has a DC voltage source (DC, +/−), a DC voltage changeover switch 9, an AC voltage source (AC, LUN) and an AC voltage changeover switch 10.

The circuit arrangement 8 is designed in such a way that either a DC or an AC three-point actuating signal can be applied to the input terminal block 11 of the drive apparatus 1, but not an AC and a DC signal at the same time.

The circuit arrangement 8 merely illustrates the way in which the illustrated embodiments function and is not a constituent part of the illustrated embodiments.

The function of the drive apparatus 1 will be explained below. As has already been mentioned, the drive apparatus 1 is designed in such a way that it can be controlled by AC voltage and DC voltage three-point actuating signals. A three-point actuating signal is generally understood to mean a signal for controlling actuators which identify three states: open, close and stop. In the case of an actuator which is controlled by a motor, these states correspond to the signals counterclockwise rotation (for example: closed), clockwise rotation (for example: open) and no movement, i.e., the actuator remains in the initial position (for example in a central position).

To control the drive apparatus 1 via DC voltage three-point actuating signals, a DC voltage is applied to the individual terminals (denoted by (+)L↑ and by (−)L↓) of the terminal block 11. The individual terminal denoted by N of the terminal block 11 in this case remains unoccupied and, therefore, without a function.

To match DC voltage three-point actuating signals, the matching circuit 2 has a DC voltage module 12, which only connects DC voltage, irrespective of its polarity, through to a motor driver 13 and converts the connected-through DC voltage into a value which can be processed by the motor driver 12 corresponding to predeterminable parameters, such as voltage level, for example. The motor driver 13 identifies the polarity of the DC voltage, which is at the individual terminals (+)L↑ and (−)L↓ and is then converted by the DC voltage module 12, and controls the drive 3 correspondingly (counterclockwise rotation, clockwise rotation).

To match AC voltage three-point actuating signals, the matching circuit 2 has two rectifiers 14, two standard optocouplers 15, two direction-indicating optocouplers 16, a constant current regulator 17 and an AC/DC voltage converter power supply unit 18.

To control the drive apparatus 1 by means of AC voltage three-point actuating signals, an AC voltage signal is applied to either the individual terminals of the terminal block 11, which are denoted by (+)L↑ and by N, or to the individual terminals of the terminal block 11, which are denoted by (−)L↓ and by N. In both cases, the AC voltage applied between (+)L↑ and N or (−)L↓ and N is rectified by the rectifier 14, which is connected to the corresponding input. The power supply unit 18 is supplied with AC voltage through the standard optocoupler 15, which is connected to the respective input (+)L↑ or (−)L↓. The power supply unit 18 converts the applied AC voltage corresponding to predeterminable parameters into a DC voltage, which can be processed by the motor driver 13, for feeding the drive 3.

The respective direction of rotation is signaled to the motor driver 13 through the direction-indicating optocouplers 16, which are connected to the respective input (+)L↑ or (−)L↓ (in series with the rectifier 14 and the standard optocoupler 15), via the inputs of said motor driver 13 which are denoted by ↑ and ↓.

To protect the components denoted by the reference symbols 14, 15 and 16 from overcurrents, the current flowing through them is limited to a value which is non-damaging for these components by means of the constant current regulator 17.

If, impermissibly, an AC signal is applied to the two inputs (+)L↑ and (−)L↓, the constant current regulator 17 limits the current flowing through the components denoted by the reference symbols 14, 15 and 16 to a value which prevents both standard optocouplers 15 from being connected and undefined switching states from being set.

The invention is not restricted to the illustrated embodiments described, which can be modified in a variety of ways.

For example, the drive apparatus 1 may have a drive 3, which has a higher breakaway torque during starting. The drive apparatus 1 can furthermore have means which make it possible to change the rotation speed and/or to limit the torque of the drive 3. Furthermore, the drive apparatus 1 may have overload means, which prevent overheating of and damage, as a result of excessively high temperatures, to the drive 3. This can be achieved, for example, by a drive temperature being monitored and by the drive 3 being shut down in the event of an excessively high drive temperature.

In the illustrated embodiments, the three-point actuating signal transmits energy and information with the same signal both on the input side and on the output side of the matching circuit 2. However, it is conceivable to split this unit and to use separate signals and/or transmission paths. Thus, for example, energy can be transmitted using cables and (directional) information can be transmitted, for example, wirelessly.

The disclosed matching circuit 2 can also be used for actuators driven by hydraulic or pneumatic drives. In this case, intermediate elements that can be switched and controlled by electrical signals of the matching circuit 2, such as hydraulic or pneumatic valves, for example, are interposed.

1. A drive apparatus which can be controlled by a three-point actuating signal, the drive apparatus comprising:
a drive for driving an actuator; and
a matching circuit for matching the three-point actuating signal to predeterminable parameters.

2. The drive apparatus of claim 1, wherein the predeterminable parameters are one or more of the following:
type of voltage (AC/DC), voltage value, current value or frequency of the three-point actuating signal.

3. The drive apparatus of claim 1, wherein the predeterminable parameters are one or more of the following:
type of voltage (AC/DC), voltage value range, current value range or frequency range of the three-point actuating signal.

4. The drive apparatus of claim 1, wherein the drive is an electric motor.

5. The drive apparatus of claim 4, wherein the electric motor is a brushless and collectorless electric motor.

6. The drive apparatus of claim 1, wherein the drive is a hydraulic motor which can be controlled by means of electrical signals.

7. The drive apparatus of claim 1, wherein the drive is a pneumatic motor which can be controlled by means of electrical signals.

8. The drive apparatus of claim 1, wherein the drive apparatus is coupled to a circuit arrangement is designed in such a way that either a DC or an AC three-point actuating signal can be applied to inputs of the drive apparatus, but not an AC and a DC signal at the same time.

9. The drive apparatus of claim 1, wherein the matching circuit has at least one constant current regulating means.

10. The drive apparatus of claim 1, wherein the matching circuit has at least one means for optically coupling electrical signals.

11. The drive apparatus of claim 1, wherein the matching circuit has at least one means with a voltage matching function.

12. The drive apparatus of claim 1, wherein the matching circuit has a DC voltage module, which only connects DC voltage, irrespective of its polarity, through to a motor driver and converts the connected-through DC voltage into a value which can be processed by the motor driver, corresponding to predeterminable parameters.

13. The drive apparatus of claim 1, wherein the matching circuit, for the purpose of matching AC voltage three-point actuating signals, has two rectifiers, two standard optocouplers, two direction-indicating optocouplers, a constant current regulator and an AC/DC voltage converter.
